(19) United States
(12) Patent Application Publication
(10) Pub. No.: US 2026/0050321 A1
(43) Pub. Date: Feb. 19, 2026

(54) METHOD AND SYSTEM FOR REDUCING DATA AMOUNT

(71) Applicant: HTC Corporation, Taoyuan City (TW)

(72) Inventor: Wei-Jen Chung, Taoyuan City (TW)

(73) Assignee: HTC Corporation, Taoyuan City (TW)

(21) Appl. No.: 19/299,351

(22) Filed: Aug. 14, 2025

Related U.S. Application Data
(60) Provisional application No. 63/682,803, filed on Aug. 14, 2024.

(51) Int. Cl. G06F 3/01

(52) U.S. Cl. CPC G06F 3/011; G06F 3/017

(57) ABSTRACT

The embodiments of the disclosure provide a method and system for reducing data amount. The method includes: tracking a first pose data of each of a plurality of first joints on a first body part, wherein the first body part comprises a first extension portion having a plurality of second joints among the first joints; converting the first pose data of each of the first joints into a second pose data of each of the first joints with respect to a reference joint among the first joints; reducing the second pose data of the second joints based on a first base joint of the second joints; generating a plurality of first data points by feeding the second pose data of each of the first joints into an encoder of an autoencoder; and transmitting the first data points.

### CROSS-REFERENCE TO RELATED APPLICATION

This application claims the priority benefit of U.S. provisional application Ser. No. 63/682,803, filed on Aug. 14, 2024. The entirety of the above-mentioned patent application is hereby incorporated by reference herein and made a part of this specification.

### BACKGROUND OF THE INVENTION

### 1. Field of the Invention

The present disclosure generally relates to a mechanism for managing data, in particular, to a method and system for reducing data amount.

### 2. Description of Related Art

Extended Reality (XR) technology encompasses Virtual Reality (VR), Augmented

Reality (AR), and Mixed Reality (MR), providing immersive digital experiences by integrating virtual elements with the real world. XR applications rely on real-time data transmission to enhance user interaction, whether in gaming, training simulations, remote collaboration, or other interactive environments.

In the transmission of XR-related data, in addition to the user's head and the handheld controllers, it may also be necessary to transmit information regarding body joints, facial expressions, and eye movements.

In a multi-user networked environment of XR (e.g., a multi-user gaming scenario), the host (e.g., a head-mounted display) corresponding to each player has to send their own data (e.g., the data mentioned in the above) to a server, which then relays the information to the hosts corresponding to all other players. The amount of data transmitted and received per frame may significantly increase when the number of participants increases.

In this case, it may be beneficial to design a mechanism for reducing the amount of data.

### SUMMARY OF THE INVENTION

Accordingly, the present disclosure is directed to a method and system for reducing data amount, which can be used to solve the above technical problem.

The embodiments of the disclosure provide a method for reducing data amount. The method includes: tracking, by a first host, a first pose data of each of a plurality of first joints on a first body part, wherein the first body part comprises a first extension portion having a plurality of second joints among the plurality of first joints; converting, by the first host, the first pose data of each of the plurality of first joints into a second pose data of each of the plurality of first joints with respect to a reference joint among the plurality of first joints; reducing, by the first host, the second pose data of at least one first interphalangeal joint of the plurality of second joints based on a first base joint of the plurality of second joints; generating, by the first host, a plurality of first data points by feeding the second pose data of each of the plurality of first joints into an encoder of an autoencoder; and transmitting, by the first host, the plurality of first data points.

Embodiments of the disclosure provide a system for reducing data amount, including a first host. The first host is configured to perform: tracking a first pose data of each of a plurality of first joints on a first body part, wherein the first body part comprises a first extension portion having a plurality of second joints among the plurality of first joints; converting the first pose data of each of the plurality of first joints into a second pose data of each of the plurality of first joints with respect to a reference joint among the plurality of first joints; reducing the second pose data of at least one first interphalangeal joint of the plurality of second joints based on a first base joint of the plurality of second joints; generating a plurality of first data points by feeding the second pose data of each of the plurality of first joints into an encoder of an autoencoder; and transmitting the plurality of first data points.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 shows a schematic diagram of a system according to an embodiment of the disclosure.

FIG. 2 shows a flow chart of the method for reducing data amount according to an embodiment of the disclosure.

FIG. 3 shows a schematic diagram of converting the first pose data into the second pose data according to an embodiment of the disclosure.

FIG. 4 shows another hand gesture of the tracked hand according to FIG. 3.

FIG. 5 shows a schematic diagram of reducing the second pose data according to an embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

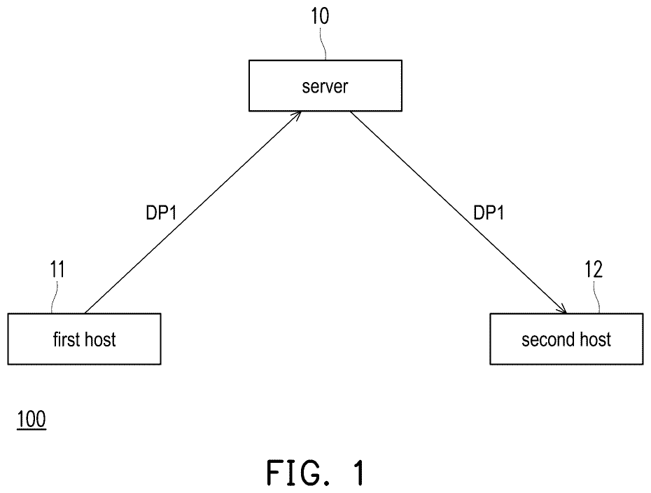

See FIG. 1, which shows a schematic diagram of a system according to an embodiment of the disclosure. In FIG. 1, the system 100 includes a server 10, a first host 11 and a second host 12.

In various embodiments, the first host 11 and/or the second host 12 can be any smart device and/or computer device that can render and provide visual contents of reality services such as virtual reality (VR) service, augmented reality (AR) services, mixed reality (MR) services, and/or extended reality (XR) services, but the disclosure is not limited thereto. In some embodiments, the host 100 can be a head-mounted display (HMD) capable of showing/providing visual contents (e.g., AR/VR/MR contents) for the wearer/user to see.

In one embodiment, the first host 11 and/or the second host 12 can be disposed with built-in displays for showing the visual contents for the user to see. Additionally or alternatively, the first host 11 and/or the second host 12 may be connected with one or more external displays, and the host 100 may transmit the visual contents to the external display(s) for the external display(s) to display the visual contents, but the disclosure is not limited thereto.

In XR-based multi-user environments, the server 10 may play a crucial role in managing real-time data transmission and synchronization among participants. The server 10 acts as a central hub, receiving input from each user, processing the data, and distributing it to all connected clients to ensure a seamless shared experience.

Depending on the architecture, the server may handle tasks such as motion tracking, environmental updates, and latency compensation to maintain consistency across users' perspectives. In high-performance XR applications, optimizing data transfer efficiency is critical, as large volumes of information—such as head, hand, and body joint poses, facial expressions, and eye movement data—must be processed and relayed with minimal delay.

By efficiently managing XR-related data, the server 10 ensures that all users remain synchronized within the virtual space, enabling real-time interactions and a cohesive immersive experience, but the disclosure is not limited thereto.

In XR-based multi-user environments, a user refers to an individual participant who interacts with the extended reality system, whether in virtual reality (VR), augmented reality (AR), or mixed reality (MR). Each user is represented within the virtual space by an avatar or digital embodiment, which mirrors their real-world movements and actions through motion tracking, hand gestures, facial expressions, and eye tracking.

Users may engage with XR environments through a combination of hosts (e.g., HMDDs), handheld controllers, hand-tracking sensors, and other input devices. Their presence and interactions are synchronized across the system, allowing for real-time collaboration, social engagement, or gameplay in shared virtual spaces.

In a multi-user XR setting, the host corresponding to each user must transmit their movement and status data to a central server (e.g., the server 10) or a peer-to-peer network, ensuring that their actions are reflected consistently across all participants' views. Efficient data transmission and processing are essential to maintaining low latency and a seamless immersive experience, especially as the number of users in the system increases.

However, as mentioned in the above, the data amount would significantly increase when the number of participants increases. Accordingly, the embodiments of the disclosure have provided a method for reducing data amount, which may be used to solve the problem.

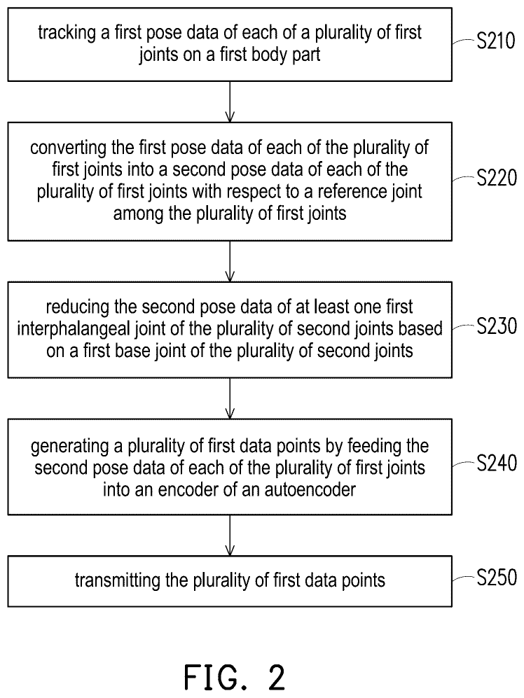

See FIG. 2, which shows a flow chart of the method for reducing data amount according to an embodiment of the disclosure. The method of this embodiment may be executed by the system 100 in FIG. 1, and the details of each step in FIG. 2 will be described below with the components shown in FIG. 1.

In step S210, the first host 11 tracks a first pose data of each of a plurality of first joints on a first body part.

In the embodiment, the first host 11 may be capable of monitoring or recording the pose data (e.g., movement and rotation) of multiple joints located on the first body part.

In some embodiments, the first body part may refer to a specific anatomical region containing multiple tracked joints and/or any anatomical structure, functional tracking unit, or joint group that is relevant to the operation of the system, allowing for precise tracking and data analysis. For example, the first body part may include a hand, an arm, a leg, a head, a foot, on a user, but the disclosure is not limited thereto.

For better understanding, the first body part considered in the following discussions would be assumed to be a hand of the user of the first host 11. In this case, the first joints on the first body part may include all of the joints on the hand, such as a wrist joint and all joints on the fingers of the hand, but the disclosure is not limited thereto.

In the embodiment, the first pose data may refer to the initial or primary set of position and rotation data captured for each first joint on the first body part.

In different embodiments, the position data and the rotation data in one first pose data may be characterized in different data forms, such as six degree-of-freedom, Euler form, or rotation on axis, but the disclosure is not limited thereto. In some embodiments, one first pose data may include several position components and several rotation components. For example, the position components may include 3 position components on X, Y, Z axis, and the rotation components may be characterized in a quaternion form including 4 components (e.g., w, x, y, z, wherein w is the scalar part of the quaternion, and x, y, z are the vector part of the quaternion) In this case, one first pose data may include 7 data points.

In some embodiments, the quaternion for of the rotation components can be transformed into the form of rotation on axis, but the disclosure is not limited thereto.

In the embodiment where the quaternion form is applied, assuming that the number of the first joints on the first body part is 26, the data amount of the first pose data of each first joint may be 182 (i.e., 26*7) dimensions, but the disclosure is not limited thereto.

In the embodiments of the disclosure, the first body part includes a first extension portion having a plurality of second joints among the plurality of first joints.

In the embodiments where the first body part is assumed to be a hand, the first extension portion may be one of the fingers on the hand, and the second joints may be the finger joints thereon.

For example, the first extension portion may be the index finger on the hand, and the second joints may include the base joint (e.g., the metacarpophalangeal joint) of the index finger and the interphalangeal joints (e.g., the proximal interphalangeal joint and the distal interphalangeal joint) on the index finger.

For another example, the first extension portion may be the thumb on the hand, and the second joints may include the base joint of the thumb and the interphalangeal joint on the thumb, but the disclosure is not limited thereto.

In various embodiments, the first host 11 may use any existing tracking mechanism for tracking the first body part (and/or other body part on the user), such as OpenPose or the like, but the disclosure is not limited thereto.

In step S220, the first host 11 converts the first pose data of each of the plurality of first joints into a second pose data of each of the plurality of first joints with respect to a reference joint among the plurality of first joints.

In various embodiments, the reference joint may be any of the first joints on the first body part. For better understanding, the reference joint considered in the following discussions would be assumed to be the base joint (e.g., the metacarpophalangeal joint) of the middle finger of the hand, but the disclosure is not limited thereto.

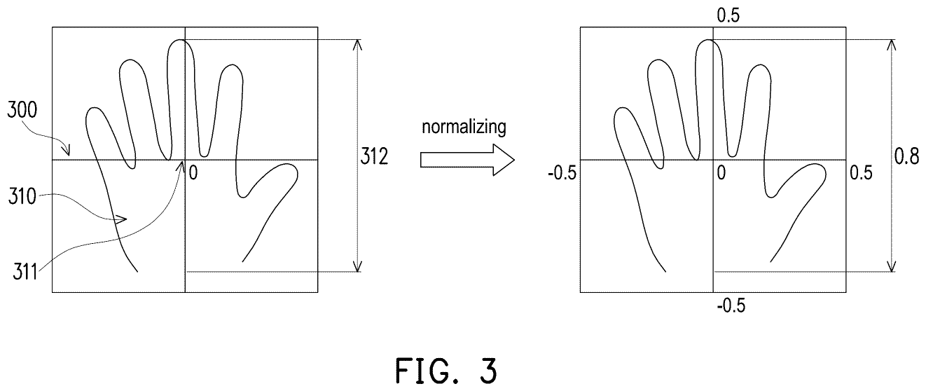

See FIG. 3, which shows a schematic diagram of converting the first pose data into the second pose data according to an embodiment of the disclosure.

In the embodiment, the first host 11 determines a first coordinate system 300, wherein the reference joint 311 (e.g., the base joint of the middle finger of the tracked hand 310) is used as an origin in the first coordinate system 300. Next, the first host 11 determines a third pose data of each of the plurality of first joints in the first coordinate system 300 based on a relative pose between the reference point 311 and each of the plurality of first joints.

In this case, the third pose data of each first joint would be characterized as the relative pose between the reference point 311 and each first joint. For example, if the position components of the first pose data of the base joint of the middle finger (i.e., the reference point 311) is (1, 1, 1), the position components of the third pose data of the base joint of the middle finger may be (0, 0, 0) since it is regarded as the origin of the first coordinate system 300. For other first joints, the corresponding third pose data may be derived based on the same principle, which would not be further provided.

Then, the first host 11 determines the second pose data of each of the plurality of first joints by normalizing the position component in the third pose data of each of the plurality of first joints based on a reference length 312.

In FIG. 3, the considered reference length 312 may be the hand length of the hand 310. In the embodiment, since the first pose data of each first joint on the hand 310 is available, the first host 11 may derive the hand length by adding the lengths of the bones connecting between the tip of the middle finger of the hand 310 and the wrist joint, but the disclosure is not limited thereto.

In other embodiments, the first host 11 may use other length as the considered reference length and not limited to the case in FIG. 3.

In one embodiment, during normalizing, the first host 11 may use the reference length 312 as 0.8 (or other figures smaller than 1) to normalize the position component in the third pose data of each first joint.

In this case, no matter what kind of hand gesture is currently performed by the hand 310, the position components of the second pose data of each first joint would range between −0.5 and +0.5 as shown on the right of FIG. 3

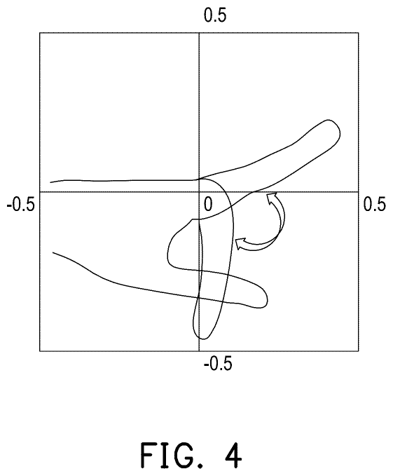

See FIG. 4, which shows another hand gesture of the tracked hand according to FIG. 3. In FIG. 4, even if the hand 310 has bent the fingers as shown, the position components of the second pose data of each first joint would still range between −0.5 and +0.5.

Accordingly, the second pose data of each first joint would be easier to be analysed/processed/understood by the machine learning models (e.g., the autoencoder) used in the subsequent procedure.

In step S230, the first host 11 reduces the second pose data of the plurality of second joints based on a first base joint of the plurality of second joints. In some embodiments, the first host 11 reduces the second pose data of at least one first interphalangeal joint of the plurality of second joints based on a first base joint of the plurality of second joints.

As mentioned in the above, the first extension portion where the second joints located can be any finger on the tracked hand 310. For better understanding, the first extension portion considered in the following discussions would be assumed to be the index finger of the hand 310, but the disclosure is not limited thereto.

In this case, the considered first base joint may be the base joint of the index finger, and the considered first interphalangeal joints may be the proximal interphalangeal joint and the distal interphalangeal joint of the index finger.

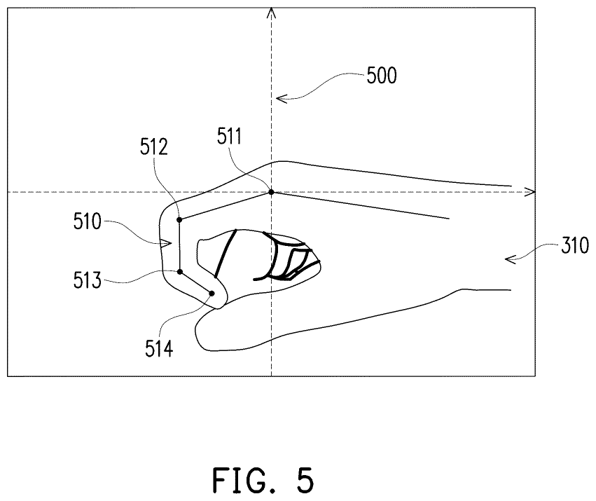

See FIG. 5, which shows a schematic diagram of reducing the second pose data (of the first interphalangeal joint) according to an embodiment of the disclosure.

In FIG. 5, the first host 11 determines a second coordinate system 500 associated with the first extension portion 510 (e.g., the index finger of the hand 310), wherein the first base joint (e.g., the metacarpophalangeal joint) of the second joints 511-514 is used as an origin in the second coordinate system 510 associated with the first extension portion 511.

Next, the first host 11 determines a fourth pose data of each of the plurality of second joints 511-514 in the second coordinate system 500 associated with the first extension portion 510 based on a relative rotation between the first base joint and each of the plurality of second joints.

In this case, the fourth pose data of each of the second joints 511-514 would be characterized as the relative rotation between the first base joint (e.g., the second joint 511) and each of the second joints 511-514.

In the embodiment, although the first base joint can have rotations on all of X, Y, Z directions, the considered first interphalangeal joints would only have limited ways of rotation due to the structure of the index finger.

For example, although the first base joint (e.g., the second joint 511) can have rotations on all X, Y, Z directions, the considered first interphalangeal joints (e.g., the second joints 512-514) would only have rotations on one of the axis, e.g., the X direction.

Therefore, only one of the rotation components (e.g., the one corresponding to the X direction) of the fourth pose data of each of the first interphalangeal joints would have non-zero value, and other rotation components (e.g., the ones corresponding to the Y/Z directions) would have near-zero value.

Afterwards, the first host 11 may determine the reduced second pose data of each of the at least one first interphalangeal joint of the plurality of second joints 511-514 by removing at least a part of the plurality of rotation components in the fourth pose data of each of the at least one first interphalangeal joint.

In one embodiment, the reduced second pose data of each of the at least one first interphalangeal joint of the plurality of second joints 511-514 includes a scalar part and a single rotation component on a designated direction (e.g., the X direction).

For example, the first host 11 may remove the rotation components corresponding to the Y and Z directions in the fourth pose data of each of the second joints 512-514 (e.g., the considered first interphalangeal joint) to determine the reduced second pose data of the second joints 512-514. In this case, the reduced second pose data of each of the at least one first interphalangeal joint of the plurality of second joints 511-514 may include the scalar part (e.g., the “w” in the quaternion form) and the single rotation component (e.g., the “x” in the quaternion form) on the X direction, but the disclosure is not limited thereto.

In this case, the data amount associated with the first extension portion 510 can be reduced.

In one embodiment, the first body part may further include a second extension portion (e.g., the middle finger of the hand 310) having a plurality of third joints among the plurality of first joints, and the first host 11 may be further configured to perform: reducing, by the first host, the second pose data (of at least one second interphalangeal joint (e.g., the proximal interphalangeal joint and the distal interphalangeal joint of the middle finger)) of the plurality of third joints based on a second base joint (e.g., the metacarpophalangeal joint of the middle finger) of the plurality of third joints.

For example, the first host 11 may perform: determining a third coordinate system associated with the second extension portion, wherein the second base joint of the plurality of third joints is used as an origin in the third coordinate system associated with the second extension portion; determining a fifth pose data of each of the plurality of third joints in the third coordinate system associated with the second extension portion based on a relative pose between the second base joint and each of the plurality of third joints, wherein the fifth pose data of each of the plurality of third joints comprises a plurality of rotation components; and determining the reduced second pose data of each of the at least one second interphalangeal joint of the plurality of third joints by removing at least a part of the plurality of rotation components in the fifth pose data of each of the at least one second interphalangeal joint.

In one embodiment, the reduced second pose data of each of the at least one second interphalangeal joint of the plurality of third joints includes a scalar part and a single rotation component on a designated direction (e.g., the X direction).

For example, the first host 11 may remove the rotation components corresponding to the Y and Z directions in the fifth pose data of each of the considered second interphalangeal joints to determine the reduced second pose data thereof. In this case, the reduced second pose data of each of the considered second interphalangeal joints of the plurality of third joints may include the scalar part (e.g., the “w” in the quaternion form) and the single rotation component (e.g., the “x” in the quaternion form) on the X direction, but the disclosure is not limited thereto.

In this case, the data amount associated with the second extension portion can be reduced as well. For other extension portion (e.g., other fingers on the hand 310) on the first body part, the associated data amount can be reduced by using the similar way, which would not be further provided.

In the embodiment where the data amount of the first pose data of each first joint may be 182 dimensions, the data amount of the reduced second pose data of each first joint may be reduced to, for example, 155 dimensions, but the disclosure is not limited thereto.

In step S240, the first host 11 generates a plurality of first data points DP1 by feeding the second pose data of each of the plurality of first joints into an encoder of an autoencoder.

In the embodiment, for some of the first joints (e.g., the second joints on the first extension portion) whose second pose data has been reduced, the considered second pose data in step S240 would be the reduced second data determined in step S230, rather than the (original) second pose data determined in step S220.

For example, for the second joints 512-514 in FIG. 5, the corresponding second pose data fed into the encoder would be the reduced second pose data, rather than the original second pose data determined in FIG. 3, but the disclosure is not limited thereto.

In the embodiments of the disclosure, an autoencoder is a type of neural network used for unsupervised learning, primarily for dimensionality reduction, feature extraction, and data denoising. It consists of two main components: an encoder and a decoder. The network is trained to reconstruct its input, learning a compact representation of the data in the process. Autoencoders are widely used in applications such as image compression, anomaly detection, and latent space learning.

The encoder is the first part of an autoencoder. Its primary function is to map the input data to a lower-dimensional latent space representation. It achieves this by applying a series of nonlinear transformations using neural network layers. The output of the encoder is often referred to as the latent vector or bottleneck representation, which captures the most essential features of the input while discarding noise and redundant information.

The decoder is the second part of an autoencoder. It takes the latent representation produced by the encoder and reconstructs the original input data. The decoder essentially performs the inverse mapping of the encoder, attempting to recover the input with minimal reconstruction loss. The effectiveness of an autoencoder depends on how well the decoder can generate an accurate approximation of the original input from the compressed latent space.

In the embodiments of the disclosure, the autoencoder may be pre-trained to carry out the above operations.

Since an unsupervised learning/training approach is used, the training data does not need to be labelled. The training dataset may include one minute of recorded hand movement data, where both hands perform various possible gestures. The left-hand data is mirrored to simulate right-hand movements. The autoencoder may trained only on right-hand data or left-hand data.

In one embodiment, when retrieving the pose data of the joints on, for example, the right-hand, these pose data may be understood as the first pose data in step S210 and subsequently processed by using the concept of steps S220 and S230 to determine the corresponding (reduced) second pose data.

In the embodiment, the (reduced) second pose data associated with the training dataset can be used as training data for training the autoencoder, such that the training speed and accuracy can be improved.

In the embodiments where the form of rotation on axis is applied, the training speed and accuracy can be further improved since the associated rotation data would be smoother, but the disclosure is not limited thereto.

After performing step S220 and S230, the total data amount can be 155 dimensions as mentioned in the above. Accordingly, the encoder may be designed to include two hidden layers, with an input size of 155 dimensions and an output size of, for example, 10 dimensions (or other output sized preferred by the designer). The decoder may also have four layers, including two hidden layers, with an input size of 10 dimensions (or other input size corresponding to the output size of the encoder) and an output size of 155 dimensions.

Each dimension may be represented as a float in the range of [0,1]. All layers use the ReLU (Rectified Linear Unit) activation function, except for the output layer of the decoder, which uses the Sigmoid function. The Mean Squared Error (MSE) is used as the loss function, and the Adam optimizer is applied. The model is trained for 200 iterations, and the computation time is relatively short even on a regular personal computer.

In the embodiment, once the training of the autoencoder is finished, the encoder may be deployed on the first host 11 to carry out step S240.

In the embodiment, since the output size of the encoder is assumed to be 10 dimensions, the size of the first data points DP1 would be 10 dimensions as well, but the disclosure is not limited thereto.

In step S250, the first host 11 transmits the plurality of first data points DP1.

In the scenario of FIG. 1, the first host 11 may transmit the first data points DP1 to, for example, the server 10, and the server 10 may receive the first data points DP1 and forward the first data points DP1 to the second host 12. That is, the server 10 may directly forward the first data points DP1 to the second host 12 without processing/analyzing, but the disclosure is not limited thereto.

In some embodiments, the first host 11 itself may operate as the server. In this case, the first host 11 may directly send the first data points DP1 to the second host 12, but the disclosure is not limited thereto.

In a first embodiment, the second host 12 may receive the plurality of first data points DP1. In the embodiment, once the training of the autoencoder is finished, the decoder may be deployed on the second host 12, such that the second host 12 may determine the (reduced) second pose data of each of the plurality of first joints by feeding the plurality of first data points into the decoder of the autoencoder. Next, the second host 12 may rebuild the first pose data of each of the plurality of first joints based on the second pose data of each of the plurality of first joints. For example, the second host 12 may rebuild the first pose data of each first joint by using the principle of inverse kinematics, but the disclosure is not limited thereto.

In this case, the second host 12 can be regarded as already obtaining the first pose data of each first joint tracked in step S210. Accordingly, the second host 12 may control a visual content (e.g., the VR/AR/MR content) based on the rebuilt first pose data of each of the plurality of first joints.

In some embodiments, the second host 12 can also perform steps S210 to S240. In this case, the considered first body part may be the hand of the user of the second host 12, but the disclosure is not limited thereto.

For carrying out step S240, the second host 12 can also be deployed with the encoder for outputting the corresponding first data points. Thereafter, the second host 12 can also transmit the corresponding first data points to the server 10 for the server 10 to forward it to other hosts (e.g., the first host 11), but the disclosure is not limited thereto.

In some embodiments where the first host 11 operates as the server, the second host 12 may transmit the corresponding first data points to the first host 11. In this case, the first host 11 may be deployed with the decoder and performing the operations discussed in the first embodiment. In addition, the first host 11 may also forward the received data points of the second host 12 to other hosts, such that other hosts deployed with the decoder can perform the operations discussed in the first embodiment, but the disclosure is not limited thereto.

In summary, the embodiments of the disclosure provide a solution to transform the raw pose data into other forms of pose data, which improves the training speed and accuracy of the autoencoder. Accordingly, the data amount for characterizing the pose data can be reduced, which improves the efficiency and speed of the data exchange process between the hosts in a multi-user networked environment.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for reducing data amount, comprising:
tracking, by a first host, a first pose data of each of a plurality of first joints on a first body part, wherein the first body part comprises a first extension portion having a plurality of second joints among the plurality of first joints;
converting, by the first host, the first pose data of each of the plurality of first joints into a second pose data of each of the plurality of first joints with respect to a reference joint among the plurality of first joints;
reducing, by the first host, the second pose data of the plurality of second joints based on a first base joint of the plurality of second joints;
generating, by the first host, a plurality of first data points by feeding the second pose data of each of the plurality of first joints into an encoder of an autoencoder; and
transmitting, by the first host, the plurality of first data points.

2. The method according to claim 1, wherein the first body part is a hand of a user of the first host, the first extension portion is a finger on the hand.

3. The method according to claim 1, wherein the first pose data of each of the plurality of first joints comprises a position component, and converting the first pose data of each of the plurality of first joints into the second pose data of each of the plurality of first joints with respect to the reference joint among the plurality of first joints comprises:
determining a first coordinate system, wherein the reference joint is used as an origin in the first coordinate system;
determining a third pose data of each of the plurality of first joints in the first coordinate system based on a relative pose between the reference point and each of the plurality of first joints; and
determining the second pose data of each of the plurality of first joints by normalizing the position component in the third pose data of each of the plurality of first joints based on a reference length.

4. The method according to claim 3, wherein the first body part is a hand of a user of the first host, and the reference length is a hand length of the hand.

5. The method according to claim 1, wherein reducing the second pose data of the plurality of second joints based on the first base joint of the plurality of second joints comprises:
determining a second coordinate system associated with the first extension portion, wherein the first base joint of the plurality of second joints is used as an origin in the second coordinate system associated with the first extension portion;
determining a fourth pose data of each of the plurality of second joints in the second coordinate system associated with the first extension portion based on a relative rotation between the first base joint and each of the plurality of second joints, wherein the fourth pose data of each of the plurality of second joints comprises a plurality of rotation components; and
determining the reduced second pose data of each of at least one first interphalangeal joint of the plurality of second joints by removing at least a part of the plurality of rotation components in the fourth pose data of each of the at least one first interphalangeal joint.

6. The method according to claim 5, wherein the reduced second pose data of each of the at least one first interphalangeal joint of the plurality of second joints comprises a scalar part and a single rotation component on a designated direction.

7. The method according to claim 1, wherein the first body part further comprises a second extension portion having a plurality of third joints among the plurality of first joints, and the method further comprises:
reducing, by the first host, the second pose data of the plurality of third joints based on a second base joint of the plurality of third joints.

8. The method according to claim 7, wherein reducing the second pose data of the plurality of third joints based on the second base joint of the plurality of third joints comprises:
determining a third coordinate system associated with the second extension portion, wherein the second base joint of the plurality of third joints is used as an origin in the third coordinate system associated with the second extension portion;
determining a fifth pose data of each of the plurality of third joints in the third coordinate system associated with the second extension portion based on a relative pose between the second base joint and each of the plurality of third joints, wherein the fifth pose data of each of the plurality of third joints comprises a plurality of rotation components; and
determining the reduced second pose data of each of at least one second interphalangeal joint of the plurality of third joints by removing at least a part of the plurality of rotation components in the fifth pose data of each of the at least one second interphalangeal joint.

9. The method according to claim 1, further comprising:
receiving, by a second host, the plurality of first data points;
determining, by the second host, the second pose data of each of the plurality of first joints by feeding the plurality of first data points into a decoder of the autoencoder;
rebuilding, by the second host, the first pose data of each of the plurality of first joints based on the second pose data of each of the plurality of first joints; and
controlling, by the second host, a visual content based on the rebuilt first pose data of each of the plurality of first joints.

10. The method according to claim 1,
receiving, by a server, the plurality of first data points; and
forwarding, by the server, the plurality of first data points.

11. A system for reducing data amount, comprising:
a first host, configured to perform:
tracking a first pose data of each of a plurality of first joints on a first body part, wherein the first body part comprises a first extension portion having a plurality of second joints among the plurality of first joints;
converting the first pose data of each of the plurality of first joints into a second pose data of each of the plurality of first joints with respect to a reference joint among the plurality of first joints;
reducing the second pose data of the plurality of second joints based on a first base joint of the plurality of second joints;
generating a plurality of first data points by feeding the second pose data of each of the plurality of first joints into an encoder of an autoencoder; and
transmitting the plurality of first data points.

12. The system according to claim 11, wherein the first body part is a hand of a user of the first host, the first extension portion is a finger on the hand.

13. The system according to claim 11, wherein the first pose data of each of the plurality of first joints comprises a position component, and the first host is configured to perform:
determining a first coordinate system, wherein the reference joint is used as an origin in the first coordinate system;
determining a third pose data of each of the plurality of first joints in the first coordinate system based on a relative pose between the reference point and each of the plurality of first joints; and
determining the second pose data of each of the plurality of first joints by normalizing the position component in the third pose data of each of the plurality of first joints based on a reference length.

14. The system according to claim 13, wherein the first body part is a hand of a user of the first host, and the reference length is a hand length of the hand.

15. The method according to claim 11, wherein the first host is configured to perform:
determining a second coordinate system associated with the first extension portion, wherein the first base joint of the plurality of second joints is used as an origin in the second coordinate system associated with the first extension portion;
determining a fourth pose data of each of the plurality of second joints in the second coordinate system associated with the first extension portion based on a relative rotation between the first base joint and each of the plurality of second joints, wherein the fourth pose data of each of the plurality of second joints comprises a plurality of rotation components; and
determining the reduced second pose data of each of at least one first interphalangeal joint of the plurality of second joints by removing at least a part of the plurality of rotation components in the fourth pose data of each of the at least one first interphalangeal joint.

16. The system according to claim 15, wherein the reduced second pose data of each of the at least one first interphalangeal joint of the plurality of second joints comprises a scalar part and a single rotation component on a designated direction.

17. The method according to claim 11, wherein the first body part further comprises a second extension portion having a plurality of third joints among the plurality of first joints, and the first host is further configured to perform:
reducing, by the first host, the second pose data of the plurality of third joints based on a second base joint of the plurality of third joints.

18. The system according to claim 17, wherein the first host is configured to perform:
determining a third coordinate system associated with the second extension portion, wherein the second base joint of the plurality of third joints is used as an origin in the third coordinate system associated with the second extension portion;
determining a fifth pose data of each of the plurality of third joints in the third coordinate system associated with the second extension portion based on a relative pose between the second base joint and each of the plurality of third joints, wherein the fifth pose data of each of the plurality of third joints comprises a plurality of rotation components;
determining the reduced second pose data of each of at least one second interphalangeal joint of the plurality of third joints by removing at least a part of the plurality of rotation components in the fifth pose data of each of the at least one second interphalangeal joint.

19. The system according to claim 11, further comprising a second host configured to perform:
receiving the plurality of first data points;
determining the second pose data of each of the plurality of first joints by feeding the plurality of first data points into a decoder of the autoencoder;
rebuilding the first pose data of each of the plurality of first joints based on the second pose data of each of the plurality of first joints; and
controlling a visual content based on the rebuilt first pose data of each of the plurality of first joints.

20. The system according to claim 11, further comprising a server configured to perform:
receiving the plurality of first data points; and
forwarding the plurality of first data points.
